(19) United States
(12) Patent Application Publication
(10) Pub. No.: US 2024/0033832 A1
(43) Pub. Date: Feb. 1, 2024

(54) Rotary Tool and Method for Manufacturing Such a Rotary Tool

(71) Applicant: KENNAMETAL INC., Latrobe, PA (US)

(72) Inventors: Patrick Kuhlemann, Fuerth (DE); Jürgen Schwägerl, Vohenstrauss (DE)

(21) Appl. No.: 18/221,527

(22) Filed: Jul. 13, 2023

(30) Foreign Application Priority Data
Jul. 26, 2022 (DE) 102022207653.2

(51) Int. Cl. B23B 51/00

(52) U.S. Cl. CPC B23B 51/00; B23B 2251/40; B23B 2251/18

(57) ABSTRACT

The invention relates to a rotary tool (2), comprising: a main blade (4), a chip flute (6), a lateral surface (8), and a flank (10) trailing after the main blade (4), wherein the flank (10) first drops off proceeding from the main blade (4) and then rises again, such that a sink (12) is formed, to which a ridge (14) adjoins, which reaches up to the lateral surface (8) and the chip flute (6). The invention further relates to a method for manufacturing a rotary tool (2).

### RELATED APPLICATION DATA

The present application claims priority under 35 U.S.C. § 119 to German Patent Application No. 102022207653.2, filed on Jul. 26, 2022, the disclosure of which is incorporated by reference herein in its entirety.

### FIELD

The invention relates to a rotary tool and a method for manufacturing such a rotary tool.

### BACKGROUND

An example of a rotary tool is a drill. Such a rotary tool regularly comprises a number of main blades that engage with the workpiece while in operation and lift a chip from the workpiece. The main blade and its cutting behavior are determined, among other things, by a flank, which, proceeding from the main blade, trails after it and, together with a cutting plane perpendicular to the longitudinal axis of the rotary tool, defines the so-called clearance angle.

The larger the clearance angle, the steeper the clearance surface will decrease and the stronger the body of the rotary tool will be truncated. A large clearance angle is advantageous on the one hand, but also leads to the disadvantage that the rotary tool is less stable during operation.

SUMMARY

In light of the foregoing, the problem addressed by the invention is to specify an improved rotary tool as well as a suitable method for its manufacture. In particular, the disadvantage described above is to be minimized.

The problem is solved according to the invention by a rotary tool having the features according to claim 1 and by a method having the features according to claim 12. Advantageous configurations, further developments, and variants are the subject matter of the subclaims. The statements made in connection with the rotary tool also apply to the method and vice versa.

The rotary tool comprises a main blade, a chip flute, a lateral surface, and a flank, which are in particular respectively part of a body of the rotary tool. The flank and the main blade are part of a tool tip of the rotary tool, which is configured on the front side of the body. The body generally extends in an axial direction and along a longitudinal axis, about which the rotary tool rotates in a circumferential direction while in operation. The lateral surface bounds the body in the radial direction, i.e., perpendicular to the axial direction. The main blade is configured frontwards on the body, i.e., on the front side, and extends roughly in the radial direction, and terminates in particular at the lateral surface. While in operation, the main blade engages with a workpiece in order to lift a chip off of the latter, which is then transported away in particular via a different chip flute.

The flank trails after the main blade (i.e., lies behind it in relation to the circumferential direction) and extends from the main blade up to the lateral surface and to the chip flute. This flute is in particular not the chip flute that adjoins the aforementioned main blade and leads up to it, but in particular a chip flute of a further main blade of the rotary tool, i.e., the chip flute meant here trails after the main blade meant here. The flank is generally arranged on the front side and faces forward, thus forming the face of the rotary tool, so to speak. While in operation, the flank forms the so-called clearance angle with a cutting plane (also referred to as the working plane), which extends perpendicular to the axial direction.

In the present case, the flank first drops off proceeding from the main blade and then rises again, such that a sink is formed, to which a ridge adjoins, which extends up to the lateral surface and the chip flute. This is particularly understood to mean that flank initially drops off proceeding from the main blade and counter to the circumferential direction in the axial direction towards the rear side of the rotary tool and then rises again inversely towards the front side of the rotary tool. The aforementioned sink is thereby formed behind the main blade, i.e., being a part of the flank, which is offset rearwardly opposite the remaining flank in the axial direction. The aforementioned ridge adjoins the sink. The sink has a base, which marks a lowest point of the flank, beyond which the ridge then projects in the axial direction. Compared to the sink, the ridge is thus arranged further forward in the axial direction. However, the ridge does not extend beyond the main blade in the axial direction, but rather is offset rearwardly opposite the main blade and in particular does not form a further blade.

The sink and the ridge produce a characteristic variation of the clearance angle in particular when viewed in a direction perpendicular to both the main blade and the longitudinal axis. Proceeding from the main blade and towards the sink, the clearance angle remains constant or even increases, and at least does not decrease. Only in the sink does the clearance angle become progressively smaller and ultimately negative while extending away from the main blade, at least until the sink ends and the ridge begins. In other words, at any given point, the flank forms an angle with a radial plane (which is subtended by the longitudinal axis and the main blade), which is initially at least 93° and preferably greater than 96° proceeding from the main blade (i.e., in particular, the clearance angle is at least 3° and regularly even 6° or more). While passing through the sink, the angle changes and, in particular, is ultimately less than 90° from the lowest point and at least at the end of the sink. Along the ridge, the angle is preferably again at least 90°, i.e., the clearance angle is greater than or equal to 0°, but this is not mandatory.

When viewed in the radial direction, the flank increases towards the tip, depending on the selected tip angle. The behavior in the radial direction is less relevant in the present case, however; what is more important is the specific extension of the flank with increasing distance from the main blade.

One advantage of the invention is in particular that, on the one hand, with the sink, an advantageously large clearance is formed behind the main blade and, on the other hand, a particularly large amount of material of the body is nevertheless present due to the ridge on the front side. The sink reduces the friction of the rotary tool on the workpiece during operation, and the ridge also increases the stability of the rotary tool during operation. The sink also allows for improved coolant supply via an optionally existing coolant channel of the rotary tool, which will be discussed in more detail further below. Accordingly, overall, the sink is in particular not a simple, narrow groove directly behind the main blade, but rather an extensive depression of the flank relative to the trailing ridge and the leading main blade. The sink is also in particular not merely subsequently introduced into a previously manufactured flank, but is instead directly formed in the course of the manufacture of the flank. The sink is in particular also not a simple interruption of the flank, but rather an essential and characterizing component thereof. Suitably, the proportion of the sink of the entire flank is between 20% and 60%.

Preferably, the ridge is configured as a plateau. This is particularly understood to mean that the clearance angle along the ridge is only minor (i.e., in the range of 0° to)5° and/or constant, so that the ridge is predominantly straight overall. Irrespective of the foregoing, the ridge rises at a different angle analogously to the entire flank in the radial direction, depending on the configuration of the rotary tool. Proceeding from the base of the sink and measured in the axial direction, the ridge has a height suitably corresponding to at least 0.25 times a distance between the base and the main blade, also measured in the axial direction, so that the sink has a substantial depth. As already indicated, however, the ridge in any case lies in particular below the main blade, i.e., the height of the ridge is less than the aforementioned distance.

Preferably, the sink is respectively concave, i.e., in particular vaulted or curved towards the rear side of the rotary tool. A continuous change of the clearance angle is thus realized as it extends through the sink.

Preferably, the flank is convex proceeding from the main blade up to the sink, i.e., in particular vaulted towards the front side of the rotary tool. A continuous increase in the clearance angle from the main blade towards the sink is thus realized. The clearance angle thus increases with increasing distance from the main blade; this is also referred to as a “progressive clearance angle.” In combination with a convex sink, there is advantageously then a total convex-concave extension of the flank from the main blade to the sink and through it, i.e., from the main blade up to the ridge.

Preferably, the flank is also configured without edges, proceeding from the main blade up to the ridge (i.e., up to a boundary between the sink and the ridge), i.e., it has no abrupt or unstable changes in the clearance angle, but rather extends continuously overall, in particular. Optionally, the flank is overall edge-free, i.e., also the ridge itself as well as the boundary between the sink and the ridge. Alternatively, the boundary is formed by an edge, which is preferably the only edge within the entire flank.

In a preferred embodiment, the sink extends in particular continuously and uninterrupted from the lateral surface to the chip flute. In a possible embodiment, the flank is thereby subdivided into a leading partial surface and a trailing partial surface, wherein the trailing partial surface corresponds to the ridge and the leading surface extends in stripe-like manner between the sink and the main blade. Alternatively, the sink already directly adjoins the main blade. Due to the general subdivision of the flank into two parts (e.g. partial surfaces as described) by means of the sink, the flank is also referred to as a “double flank face.”

The rotary tool generally has a center and a tip. On the front side, the tip forms the end of the center when viewed in the axial direction and is thus a frontmost point of the rotary tool. The tip is in particular a part of a point thinning, with a chisel blade connecting the main blades in the center.

Suitably, the sink extends into the center and passes by the tip. In particular, the sink extends into the point thinning, if present. In the case of a sink that extends from the lateral surface to the chip flute, the sink is then normally longer than the main blade, and the length of the sink is greater than a radius of the rotary tool (more precisely: a radius of its body).

The sink described herein is particularly advantageous in combination with a coolant channel for a front-side supply of coolant. Accordingly, in a particularly preferred configuration, the rotary tool comprises a coolant channel with a mouth that lies within the sink. The mouth preferably lies entirely within the sink.

However, a design in which the mouth only partially lies within the sink, e.g. on the transition (in particular on the edge) between the sink and the ridge, is also suitable. The sink thereby advantageously overall forms a coolant bed, via which the coolant is distributed particularly optimally after exiting the mouth. In operation, the exiting coolant flows along the sink, in particular on the one hand towards the chip flute and on the other hand towards the lateral surface. In addition, advantageously, the entire length of the main blade is supplied with coolant. The sink generally has a width that corresponds to 0.8 times to 1.5 times a diameter of the mouth. The width of the sink is in particular measured perpendicular to the axial direction and at the transition from the sink to the ridge. The diameter of the mouth is measured in particular in a plane perpendicular to the axial direction.

In an advantageous embodiment, the flank has a notch for outputting coolant towards the chip flute or the lateral surface. The notch is in particular concave in shape, i.e., similar to the sink, but significantly smaller in comparison. The notch advantageously serves to further optimize the coolant flow. By means of the notch, a special outlet for the coolant is created, via which the coolant can leave the flank. In a first suitable configuration, the notch is introduced towards the chip flute and interrupts a connecting edge between the flank and chip flute for this purpose. In this case, the notch expediently runs directly from the mouth into the chip flute. Alternatively or additionally, the notch is introduced towards the lateral surface and interrupts a connecting edge between the flank and the lateral surface, in particular the aforementioned circumferential edge. In this case, the notch expediently runs directly from the sink into the lateral surface.

In a suitable configuration, the ridge and the sink, as already indicated above, abut one another along an edge and then form an angle of at least 90° there on the rear side. In particular, the edge is not a blade and does not demonstrate a cutting action during operation. The angle is measured on the rear side, i.e., into the body. The corresponding complementary angle is then at most 270° on the front side, i.e., towards the workpiece in operation. The edge is therefore overall obtuse. The angle is either constant or varied along the edge, but is always at least 90° at any position along the edge.

Preferably, the rotary tool is a drill. However, the statements made here are generally also applicable to other rotary tools, such as milling machines. The rotary tool described herein preferably comprises two, three, or four main blades, and correspondingly as many flutes, lateral surfaces, and flanks. The rotary tool is either integral, i.e., monolithic, or multi-part, e.g., modular with a separable tool tip.

The chip flute, the lateral surface and—if present—the coolant channel are respectively designed in a coiled manner, i.e., they extend helically about the longitudinal axis.

The method serves to manufacture a rotary tool, in particular a rotary tool as described above. The rotary tool comprises a main blade, a chip flute, a lateral surface, and a flank which trails after the main blade. The flank is configured so as to first drop off proceeding from the main blade and then rise again, such that a sink is formed, to which a ridge adjoins, which extends up to the lateral surface and the chip flute.

Preferably, the flank is ingrained into the body of the rotary tool in a grinding step of the method. For this purpose, in particular, a grinding wheel is used, which is guided along a corresponding grinding path and is inclined variously, as needed, in the grinding step.

In principle, it is possible to form the entire flank with the sink and the ridge in different, successive sub-steps, in particular to ingrain them. However, preferably, the entire flank is ingrained in a single grinding step along a single grinding path and with only one grinding wheel. The method is thus particularly efficient, because the flank is manufactured in a single pass. Accordingly, the configuration of the sink is primarily dependent on the selection of the grinding wheel. Especially the possibly concave configuration of the sink and its width results from the selection of a grinding wheel with a correspondingly rounded circumferential edge between the lateral surface and the end face of the grinding wheel.

### DESCRIPTION OF THE DRAWINGS

Exemplary embodiments of the invention are explained in more detail in the following with the aid of a drawing. The figures show schematically:

FIG. 1 a rotary tool,

FIG. 2 a different rotary tool,

FIG. 3 a variant of the rotary tool of FIG. 1,

FIG. 4 the rotary tool of FIG. 3 in a side view,

FIG. 5 the rotary tool of FIG. 3 in a front view,

FIG. 6 a variant of the rotary tool of FIG. 3,

FIG. 7 the rotary tool of FIG. 6 in a front view,

FIGS. 8 to 11 a manufacture of the rotary tool of FIG. 1.

### DETAILED DESCRIPTION

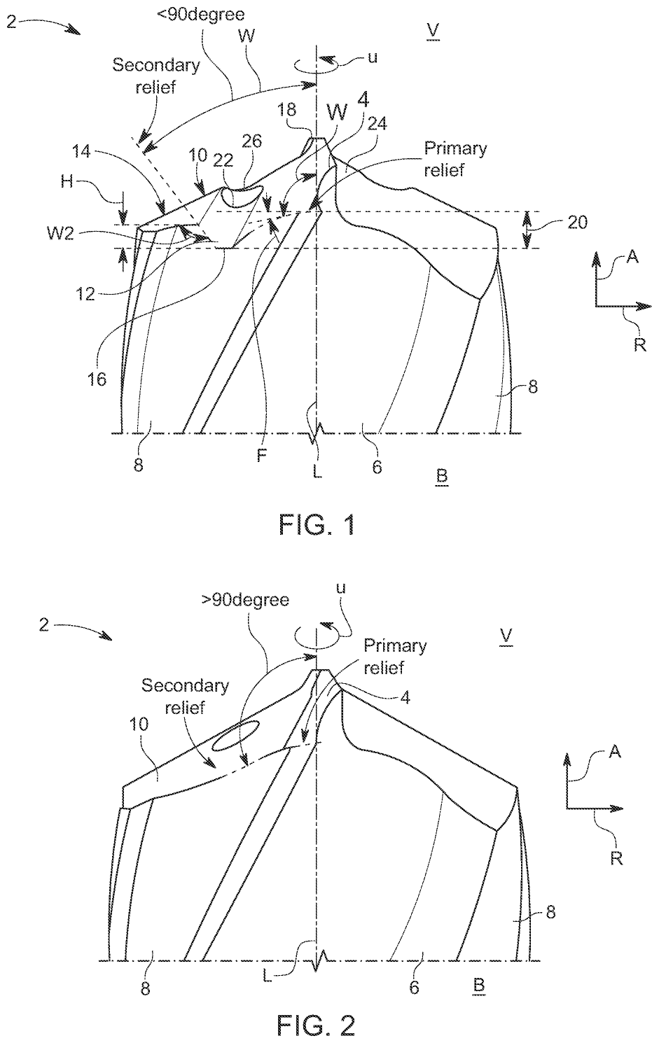

In FIG. 1, an exemplary embodiment of a rotary tool 2 according to the invention is shown in detail in a side view. For comparison, a similar view of a rotary tool 2 not according to the invention is shown in FIG. 2. In FIG. 1 as well as FIG. 2, the rotary tool 2 comprises a main blade 4, a chip flute 6, a lateral surface 8, and a flank 10, each of which are part of a body of the rotary tool 2. The flank 10 and the main blade 4 are part of a tool tip of the rotary tool 2, which is configured on the front side of the body. The body generally extends in an axial direction A and along a longitudinal axis L, about which the rotary tool 2 rotates in a circumferential direction U while in operation. The lateral surface 8 bounds the body in the radial direction R, i.e., perpendicular to the axial direction A. The main blade 4 is configured frontwards on the body, i.e., on a front side V, extends roughly in the radial direction R, and terminates at the lateral surface 8.

The flank 10 trails after the main blade 4 and extends from the main blade 4 up to the lateral surface 8 and to the chip flute 6. The flank 10 is generally arranged on the front side and faces forward, thus forming the face of the rotary tool 2, so to speak. While in operation, the flank 10 forms the so-called clearance angle F with a cutting plane (also referred to as the working plane), which extends perpendicular to the axial direction A.

In FIG. 1, the flank 10 first drops off proceeding from the main blade 4 and then, by contrast to FIG. 2, rises again, such that a sink 12 is formed, to which a ridge 14 adjoins, which extends up to the lateral surface 8 and the chip flute 6. The flank 10 initially drops off proceeding from the main blade 4 and counter to the circumferential direction U in the axial direction A towards the rear side B of the rotary tool 2 and then rises again inversely towards the front side V of the rotary tool 2. The aforementioned sink 12 is thereby formed behind the main blade 4, i.e., being a part of the flank 10, which is offset rearwardly opposite the remaining flank 10 in the axial direction A. The aforementioned ridge 14 adjoins the sink 12. Such a sink 12 and ridge 14 are missing in FIG. 2. The sink 12 has a base 16, which marks a lowest point of the flank 10, beyond which the ridge 14 then projects in the axial direction A. Compared to the sink 12, the ridge 14 is thus arranged further forward in the axial direction A. As can be seen in FIG. 1, however, the ridge 14 does not extend beyond the main blade 4 in the axial direction A, but rather is offset rearwardly opposite the main blade 4 and also does not form a further blade.

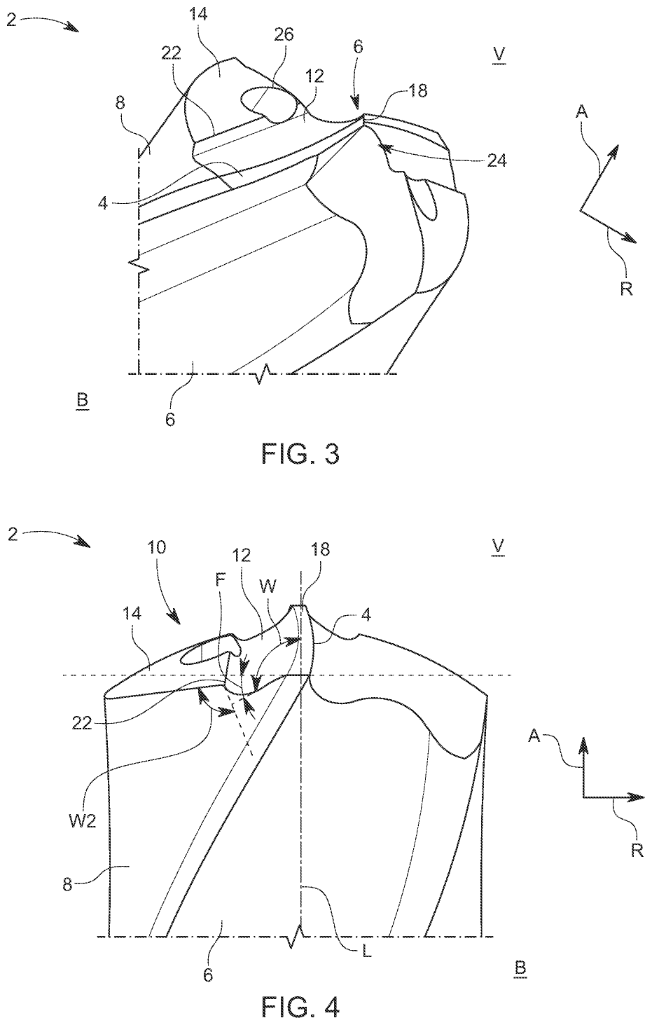

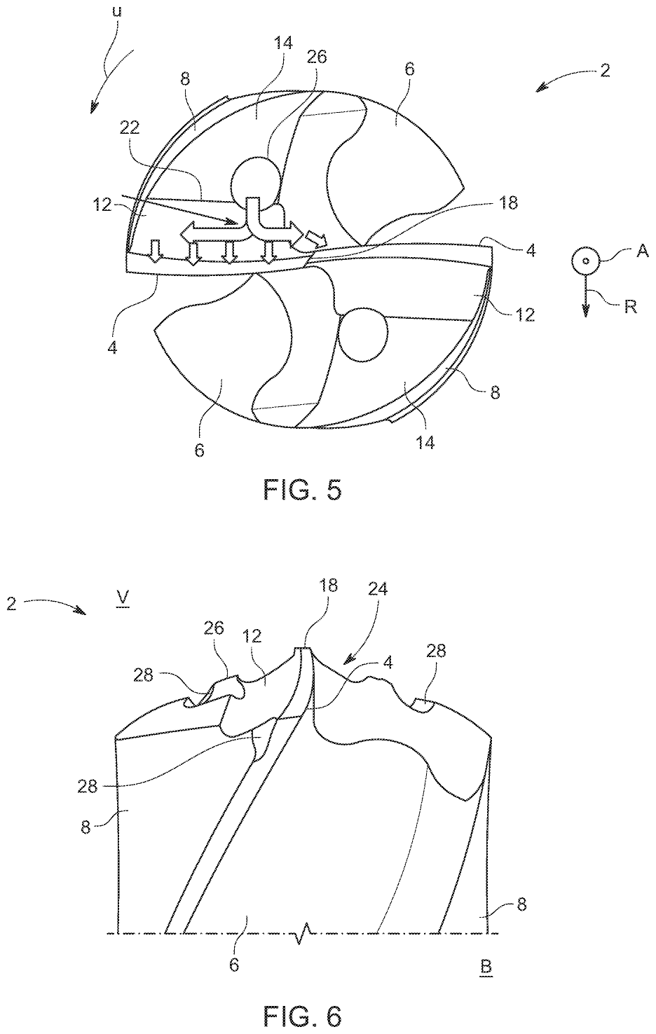

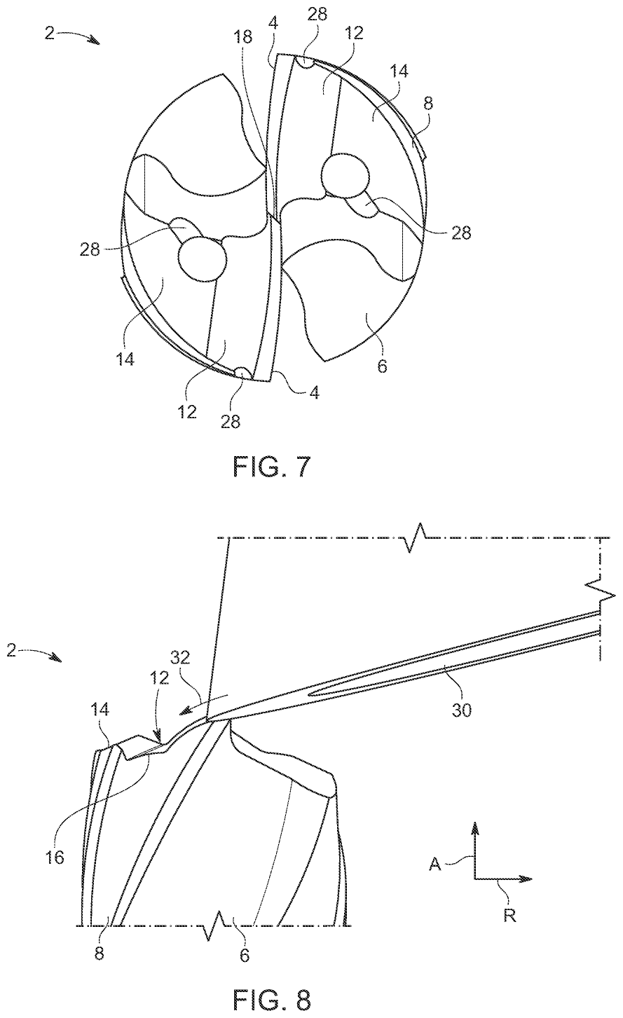

In FIGS. 3 to 5, a second exemplary embodiment for a rotary tool 2 according to the invention is shown, in FIGS. 6 and 7 a third exemplary embodiment. The statements regarding FIG. 1 apply analogously to FIGS. 3 to 7, and vice versa.

The sink 12 and the ridge 14 produce a characteristic variation of the clearance angle F in a direction perpendicular to both the main blade 4 and the longitudinal axis L, as can be seen particularly well in the side views of FIGS. 1, 4, and 6. Proceeding from the main blade 4 and towards the sink 12, the clearance angle F remains constant (not shown) or even increases, and at least does not decrease. Only in the sink 12 does the clearance angle F become progressively smaller and ultimately negative while extending away from the main blade 4, at least until the sink 12 ends and the ridge 14 begins. In other words, at any given point, the flank 10 forms an angle W with a radial plane (which is subtended by the longitudinal axis L and the main blade 4), which initially is at least 90° proceeding from the main blade 4. While passing through the sink 12, the angle W changes and is ultimately less than 90° from the lowest point. Along the ridge 14, the angle W is again at least 90° , i.e., the clearance angle F is greater than or equal to 0° , but this is not mandatory.

When viewed in the radial direction R, the flank 10 increases towards the tip 18, depending on the selected tip angle. The behavior in the radial direction R is less relevant in the present case, however; what is more important is the specific extension of the flank 10 with increasing distance from the main blade 4.

As can be seen from FIGS. 1 and 3 to 7, the sink 12 is in particular not a simple, narrow groove directly behind the main blade 4, but rather an extensive depression of the flank 10 relative to the trailing ridge 14 and the leading main blade 4. The sink 12 is also not merely subsequently introduced into a previously manufactured flank 10, but is instead directly formed in the course of the manufacture of the flank 10.

In the exemplary embodiments shown here, the ridge 14 is configured as a plateau, i.e., the clearance angle F along the ridge 14 is only minor and/or constant, so that the ridge 14 is predominantly straight overall. Irrespective of the foregoing, the ridge 14 rises at a different angle analogously to the entire flank 10 in the radial direction R, depending on the configuration of the rotary tool 2. Proceeding from the base 16 of the sink 12 and measured in the axial direction A, the ridge 14 has a height H corresponding to at least 0.5 times a distance 20 between the base 16 and the main blade 4, also measured in the axial direction A, so that the sink 12 has a substantial depth.

In the present case, the sink 12 is respectively concave, i.e., vaulted or curved towards the rear side B of the rotary tool 2. A continuous change of the clearance angle F is thus realized in the extension through the sink 12. By contrast, proceeding from the main blade 4 up to the sink 12, the flank 10 is convex, i.e., vaulted towards the front side V, so that the clearance angle F increases with increasing distance from the main blade 4 (“progressive clearance angle”). In combination with the convex sink 12, there is then a total convex-concave extension of the flank 10 from the main blade 4 to the sink 12 and through it, i.e., from the main blade 4 up to the ridge 14.

The flank 10 is also configured without edges in FIG. 1, proceeding from the main blade 4 up to the ridge 14, i.e., it has no abrupt or unstable changes in the clearance angle F, but rather extends continuously overall, in particular. However, in FIGS. 3 to 7, this is different, where an edge results approximately parallel to the main blade 4, proceeding from a margin of the lateral surface 8. In a variant not shown, the flank 10 is overall edge-free, i.e., also the ridge 14 itself as well as the boundary between the sink 12 and the ridge 14. In the exemplary embodiment shown here, however, the boundary is formed by an edge 22, which is also the only edge within the entire flank 10, at least in FIG. 1.

In the present case, the sink 12 extends continuously and uninterrupted from the lateral surface 8 to the chip flute 6. As a result, the flank 10 is subdivided into a leading partial surface and a trailing partial surface, wherein the trailing partial surface corresponds to the ridge 14 and the leading partial surface extends in stripe-like manner between the sink 12 and the main blade 4. Alternatively, the sink 12 already directly adjoins the main blade 4 (not shown).

The rotary tool 2 generally has a center and a tip 18. On the front side, the tip 18 forms the end of the center when viewed in the axial direction A and is thus a frontmost point of the rotary tool 2. The tip 18 is a part of a point thinning 24, with a chisel blade connecting the main blades 4 in the center. The sink 12 extends into the center and passes by the tip 18. In addition, the sink 12 extends into the point thinning 24. Accordingly, the sink 12 is longer than the main blade 4.

In the configurations shown here, the rotary tool 2 comprises a coolant channel, with a mouth 26 that lies within the sink 12. The mouth 26 in FIG. 1 lies completely within the sink 12 and, in FIGS. 3 to 7, lies only partially within the sink 12, here on the edge 22 by way of an example. In any case, the sink 12 forms a coolant bed, via which the coolant is distributed after exiting through the mouth 26. In operation, the exiting coolant flows along the sink 12, on the one hand towards the chip flute 6 and on the other hand towards the lateral surface 8. In addition, the entire length of the main blade 4 is supplied with coolant.

In the exemplary embodiment of FIGS. 6 and 7, the flank 10 additionally comprises a notch 28 (here four notches 28), for outputting coolant towards the chip flute 6 or the lateral surface 8. The notch 28 is shaped concavely and is introduced towards the chip flute 6 and, for this purpose, interrupts a connecting edge between the flank 10 and chip flute 6, or it is introduced towards the lateral surface 8 and, for this purpose, interrupts a connecting edge between the flank 10 and the lateral surface 8.

The ridge 14 and the sink 12 abut one another along the edge 22 and then form an angle W2 of at least 90° there on the rear side.

The rotary tool 2 shown by way of example herein is a drill. However, the statements made here are generally also applicable to other rotary tools 2.

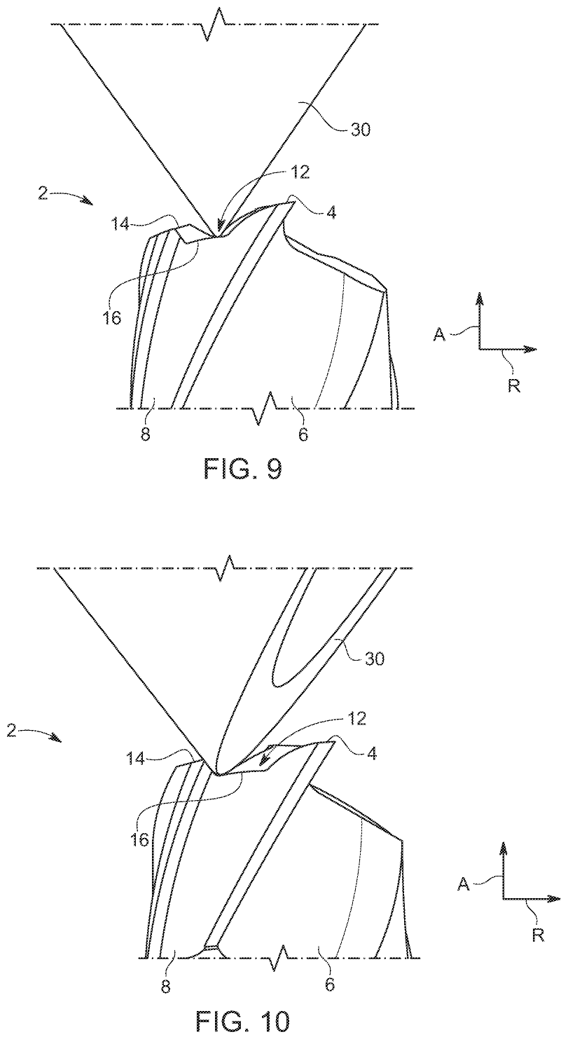

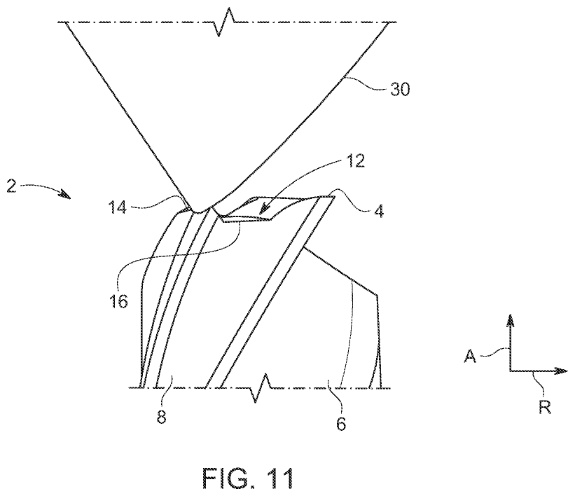

FIGS. 8 to 11 show a method for manufacturing a rotary tool 2 as described above. The flank 10 is ingrained into the body of the rotary tool 2 in a grinding step. For this purpose, a grinding wheel 30 is used, which is guided along a corresponding grinding path 32 and is inclined variously, as needed. In principle, it is possible to ingrain the flank 10 with the sink 12 in different, successive sub-steps. In the present case, however, the entire flank 10 is ingrained in a single grinding step along a single grinding path 34 and with only one grinding wheel 32. Accordingly, in FIGS. 8 to 11, four different positions of the grinding wheel 30 are shown along the grinding path 32 in order to illustrate the ingraining, wherein the positions are successive starting with FIG. 8. It is also made clear how the grinding wheel 30 is tilted during the ingraining.

1. A rotary tool comprising:
a main blade;
a chip flute;
a lateral surface; and
a flank trailing after the main blade, wherein the flank first drops off proceeding from the main blade and then rises again, such that a sink is formed, to which a ridge adjoins, which extends up to the lateral surface and the chip flute.

2. The rotary tool according to claim 1, wherein the ridge is configured as a plateau.

3. The rotary tool according to claim 1, wherein the sink is concave.

4. The rotary tool according to claim 1, wherein the flank is convex proceeding from the main blade up to the sink.

5. The rotary tool according to claim 1, wherein the flank is configured without edges proceeding from the main blade up to the ridge.

6. The rotary tool according to claim 1, wherein the sink extends from the lateral surface up to the chip flute.

7. The rotary tool according to claim 1, having a center and a tip, wherein the sink reaches into the center and passes by the tip.

8. The rotary tool according to claim 1, comprising a coolant channel having a mouth that lies within the sink.

9. The rotary tool according to claim 8, wherein the flank comprises a notch for outputting coolant towards the chip flute or the lateral surface.

10. The rotary tool according to claim 1, wherein the ridge and the sink abut one another along an edge and form an angle (W2) of at least 90° there on the rear side.

11. The rotary tool according to claim 1, wherein the latter is a drill.

12. A method for manufacturing a rotary tool that comprises a main blade, a chip flute, a lateral surface, and a flank trailing after the main blade, the method comprising:
manufacturing the flank such that it first drops off proceeding from the main blade and then rises again, such that a sink is formed, to which a ridge adjoins, which extends up to the lateral surface and the chip flute.

13. The method according to claim 12, wherein the entire flank is ingrained in a single grinding step along a single grinding path and with only one grinding wheel.
